(19) United States
(12) Patent Application Publication
(10) Pub. No.: US 2007/0101713 A1
(43) Pub. Date: May 10, 2007

(54) Turbocharger support

(75) Inventors: Josef Battig, Egliswil (CH); Marcel Meier, Ehrendingen (CH); Jean-Yves Werro, Untersiggenthal (CH); Ulrich Wellenkamp, Windisch (CH)

Correspondence Address: BUCHANAN, INGERSOLL & ROONEY PC, POST OFFICE BOX 1404, ALEXANDRIA, VA, 22313-1404, US

(73) Assignee: ABB TURBO SYSTEMS AG, Baden (CH)

(21) Appl. No.: 11/600,078

(22) Filed: Nov. 16, 2006

Related U.S. Application Data
(63) Continuation of application No. PCT/CH05/00275, filed on May 17, 2005.

(30) Foreign Application Priority Data
May 17, 2004 (EP) 04011646.9

(51) Int. Cl. F02B 33/44

(52) U.S. Cl. 60/598

(57) ABSTRACT

An exhaust-gas turbocharger with a compressor casing, turbine housing and bearing housing is supported on a base in the area of the bearing housing by means of a first support and in the area of the turbine housing by means of a second support. The second support is made in at least two parts, whereby the two parts can be moved relative to one another in the support direction. As a result, the length of the supports can be varied and counterbalance a temperature-related raising or lowering of the exhaust-gas turbocharger housing.

### CROSS REFERENCE TO RELATED APPLICATIONS

This application claims priority under 35 U.S.C. §119 to EPO Application 04011646.9 filed in Europe on 17 May 2004, and as a continuation application under 35 U.S.C. §120 to PCT/CH2005/000275 filed as an International Application on 17 May 2005 designating the U.S., the entire contents of which are hereby incorporated by reference in their entireties.

### BACKGROUND

Exhaust-gas turbochargers are disclosed, along with support for supporting an exhaust-gas turbocharger on a base.

Exhaust-gas turbochargers are used to enhance the performance of fuel engines. In the case of exhaust-gas turbochargers with radial turbines, the bearing housing is axially very short because of the compact type of design. The attachment of such exhaust-gas turbochargers to the base or to the housing of the fuel engine can be carried out in the bearing housing, whereby, as shown in FIG. 1, for reasons of rigidity, in most cases an additional support on the hot gas side is used. Such an attachment is known from the prior art and is shown and described in, for example, EP 1 331 365. The additional support imparted by the so-called pendulum support can be used to keep the exhaust-gas turbocharger from becoming excited to the resonant-frequency oscillations by the engine oscillations.

Since the temperatures of the exhaust-gas turbocharger housing in the area of the pendulum support attachment can be greater than those in the area of the bearing housing base, the exhaust-gas turbocharger on its hot gas side is raised. As a result, the turbine housing can undergo considerable shearing forces that result in housing deformations and thus in reductions of play in the area of the turbine wheel. In the extreme case, it can cause the blade wheel to graze the housing.

Thus, in addition to the support and fastening of the exhaust-gas turbocharger relative to the base as well as the absorption of oscillations of the exhaust-gas turbocharger so that the latter are not completely transferred to the base, the two supports can also be used for adjustment of thermally-induced expansions of the exhaust-gas turbocharger housing.

### SUMMARY

A support is disclosed for supporting an exhaust-gas turbocharger on a base with which the housing of the exhaust-gas turbocharger can be supported even with very great temperature fluctuations without housing deformations.

An exemplary support can be designed at least in two parts, whereby the two parts can be moved relative to one another in the support direction. As a result, the length of the support can vary and a temperature-related raising or lowering of the exhaust-gas turbocharger housing can be adjusted.

If the two parts are arranged symmetrically to one another in the connecting area, a uniform distribution of forces is thus produced. If additional clamping aids, such as, for example, cup springs, are attached symmetrically relative to the junction, a doubling or even multiplication of the clamping forces is produced. Because of the arrangement on both sides, the tolerance sensitivity can be reduced when installing the cup springs (uniform support force but double the travel).

### BRIEF DESCRIPTION OF THE DRAWINGS

Some of the features, advantages, and benefits having been stated, others will become apparent as the description proceeds when taken in conjunction with the accompanying drawings in which:

FIG. 1 shows a perspective view of a known, exemplary exhaust-gas turbocharger with a pendulum support,

FIG. 2 shows a side view of an exemplary exhaust-gas turbocharger with a multi-part pendulum support;

FIG. 3 shows diagrammatic detail drawings of an exemplary two-part pendulum supports;

FIG. 4 shows an enlarged perspective view of the exemplary pendulum support of FIG. 2; and

FIGS. 5 to 9 show sectional views through various, exemplary embodiments of multipart pendulum supports, whereby the parts of the pendulum supports in each case are connected to one another in various ways.

### DETAILED DESCRIPTION

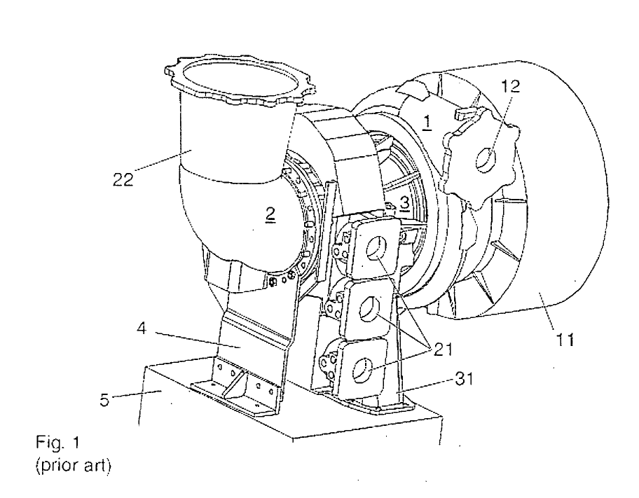

FIG. 1 shows an exemplary exhaust-gas turbocharger with exemplary housing parts, the compressor casing 1, the turbine housing 2 as well as the intervening bearing housing 3. Inside the housing, and therefore not visible in the depiction, turbine and compressor impellers as well as the bearing arrangement of the shank, which connects the two impellers to one another, can be found. The air to be sealed for the fuel engine is suctioned off via the air intake housing 11. The air intake housing is either an air intake connector, or, as in the case shown, a filter noise-damping device. The compressed air leaves the exhaust-gas turbocharger through the air outlet 12 and is fed to the cylinders of the engine. After combustion in the engine, the hot exhaust gases enter into the exhaust-gas turbochargers again via the exhaust-gas intake openings, where they are sent to drive the compressor impeller over the turbine. Above the exhaust gas outlet 22, the exhaust gases are finally sent from the exhaust-gas turbocharger to the exhaust units.

The exemplary housing can be fastened by means of two supports to the base 5, for example the housing of the combustion engine connected to the exhaust-gas turbocharger or a stable foundation. The first support is the bearing housing base 31 that carries the main weight of the exhaust-gas turbocharger. The bearing housing base supports the exhaust-gas turbocharger in its center of gravity, which should be found anywhere between the bearing housing and the turbine housing. In addition, the pendulum support 4 can be arranged, which, as mentioned above, assumes essentially vibration-engineering tasks. The pendulum support is fastened to the turbine housing by means of screws or other fastening means and is tightly connected to the base via a base attachment 51. The additional base attachment facilitates the assembly/disassembly of the exhaust-gas turbocharger, whereby instead of a separate base attachment, the pendulum support can also comprise corresponding means for anchoring in the base.

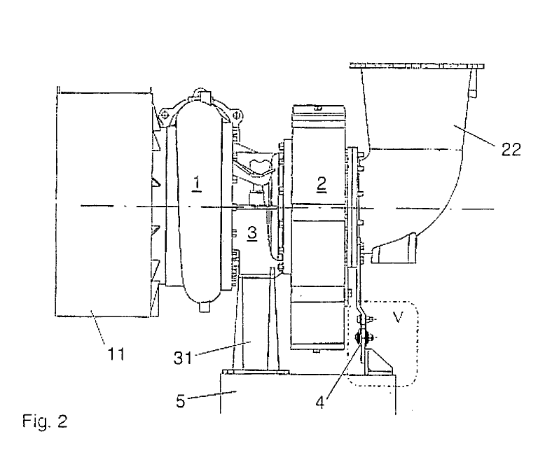

FIG. 2 shows the exemplary exhaust-gas turbocharger from the side, whereby the pendulum support that is known from the prior art is replaced by a pendulum support.

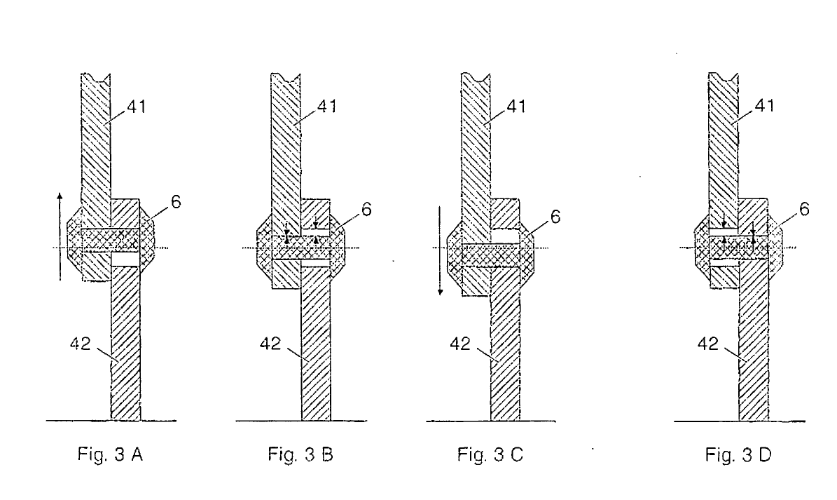

FIG. 3 shows a basic exemplary mode of operation of the simplest embodiment of the pendulum support. The latter comprises two parts 41 and 42 that can move relative to one another, whereby in this case, 41 is the upper part of the pendulum support connected to the housing of the exhaust-gas turbocharger, and 42 is the lower part connected to the base. The two parts that can be moved relative to one another in the support direction are connected to one another via an attachment piece 6. To this end, holes, in which the attachment piece is arranged, are embedded in both parts. One of the two holes, in the case of FIGS. 3A to C the hole in the lower part 42 (illustrated by means of the small arrows in the depictions) and in the case of FIG. 3D the hole in the upper part 41, has play in the support direction relative to the attachment piece, such that the respective part of the pendulum support can move relative to the attachment piece and the other portion of the pendulum support can move in the support direction.

The possible relative ability to move of the parts of the pendulum support can be determined via the embodiment of the hole that is equipped with the play relative to the attachment piece. If this hole is made as a slot oriented in the support direction, the pendulum support can expand or compress only in the support direction. By changing the orientation of the slot or by a general change in the shape of the hole, the direction of the movability can be changed. A circular hole would allow, for example, a specific, thermally-induced wobbling of the housing part supported via the pendulum support.

To ensure the support force required in the support direction over the entire area of movement extending from the position according to FIG. 3 A up to the position according to FIG. 3 C, the normal force can be adjusted to the two pendulum support parts by means of the variable clamping action of the fastening piece. At sufficiently high normal force, no movement takes place by the friction of the two parts on one another. If only the force in the support direction exceeds a boundary value, it results in movement. The deformations of the housing of the exhaust-gas turbocharger caused in the changing of temperature in the turbine area act with a great force on the pendulum support. The latter can yield, however, to the force that exceeds the friction-related boundary value and accordingly match the length thereof. In thermally-stable operation, at a uniform high or low temperature, the forces caused by the normal operation of the exhaust-gas turbocharger are not sufficient to move the two parts of the pendulum support relative to one another. In this operating state, the pendulum support behaves like a known pendulum support.

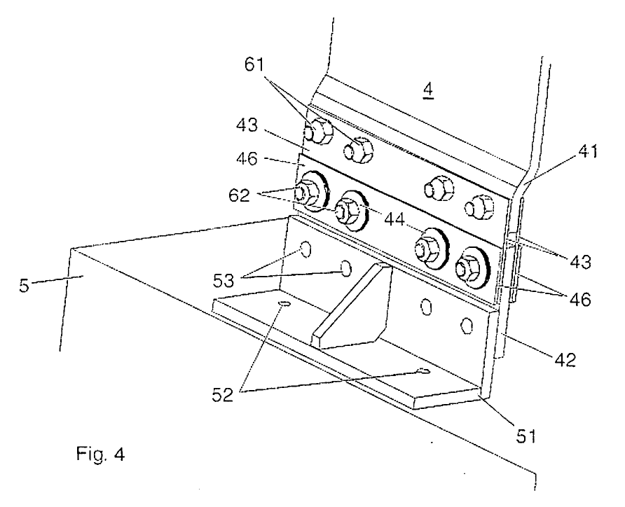

FIG. 4 shows a close-up view of another exemplary embodiment of the pendulum support, in which the base attachment 51 is also shown again in detail together with the fastening means 52 and 53. The two parts 41 and 42 of the pendulum support are in this case not connected with one another directly but rather via two other parts of the pendulum support, the connecting elements 43. These connecting elements are rigidly connected to the upper part of the pendulum support 41 via the fastening means 61. The relative movement between the two parts 41 and 43 is thus made possible via the coupling between the connecting elements 43 and the lower part 42. To define specifically the sliding behavior of the parts 42 and 43 that are directly in contact with one another, a slide plate 46 is arranged between the fastening means 62, in the form of a screw head (on the back) and a corresponding nut, and the connecting element 43. In this way, the sliding behavior is not influenced by an indefinable, possibly elevated friction resistance of the fastening means on the sliding part. The normal force acting on parts that are abrasive to one another can be produced by means of a prestressed cup spring coupling. A corresponding spring element 44, with one or more cup springs, is clamped for this purpose between fastening means and connecting elements. The advantage of the cup springs is in their surface characteristics, i.e., virtually uniform spring force at varying compression. The spring force that is produced can thus, on the one hand, be adjusted virtually independently of the production tolerances of the parts that work together in the coupling. On the other hand, however, the spring force can also be kept constant in long-term operation despite friction—induced wear of the parts and the associated flagging force of the fastening means.

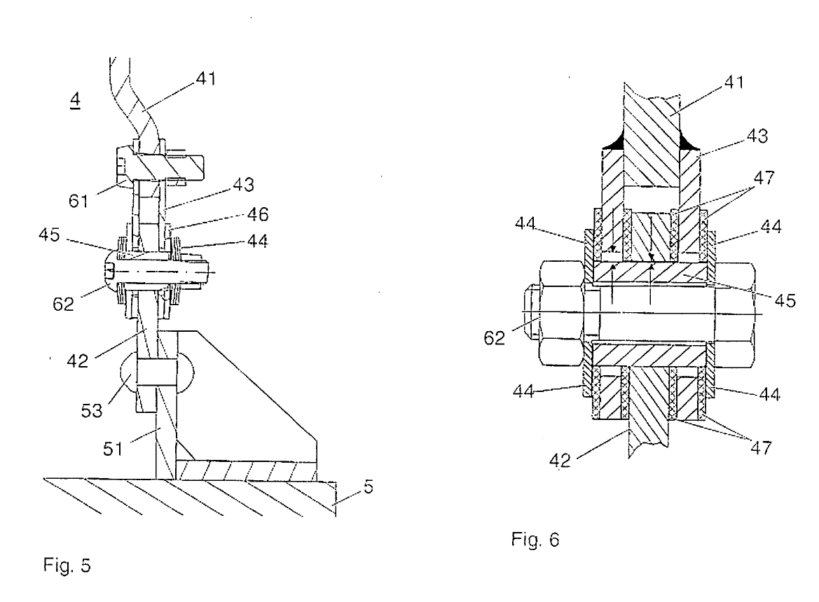

FIG. 5 shows the embodiment according to FIG. 4 in cross-section. In this case, it is illustrated once more how the two parts of the pendulum supports 41 and 42 are connected to one another via the connecting elements 43. The three cup springs 44 in each case outside of the slide plate 46 provide for the uniform application pressure. So that the latter is not too large, however, despite the spring element, a clamping limiter is provided, for example in the form of an intermediate bushing 45 pushed over the shank of the fastening means 62. The clamping limiter ensures that the fastening means does not clamp the coupling together too tightly, and thus the friction couplings experience a maximum normal force. In this way, the cup springs can always be prestressed by the same amount, for example by means of commercially available screws, independently of the starting torque, by the cup springs being tightly screwed up to the stop on the clamping limiter but no further.

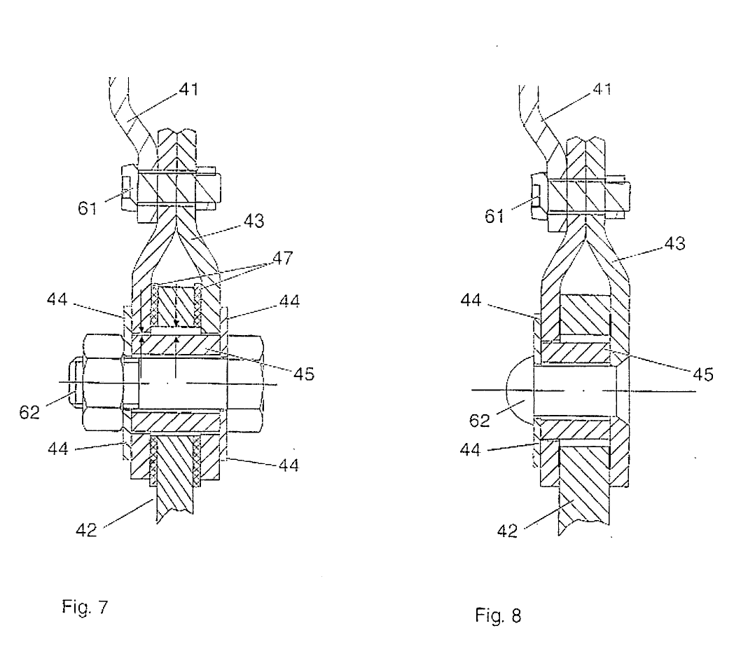

FIG. 6 and FIG. 7 show two different exemplary possibilities as to how the connecting elements 43 can be connected to the upper part of the pendulum support. In the welded embodiment according to FIG. 6, the connecting elements are a non-detachable component of the pendulum support, while in the embodiment according to FIG. 7, the screw attachments are designed in a detachable manner, and thus also the connecting elements of the pendulum support can be released.

Apart from the different fastening and geometric embodiment of the connecting elements, FIG. 6 and FIG. 7 once more illustrate the difference, already explained based on FIG. 3, relative to the play between the fastening element and one of the movable parts. The play is, as already explained in the text in FIG. 3, determined on the shape and dimension of the opening for the fastening means.

In the exemplary embodiment according to FIG. 6, the play between the shank of the fastening element 62 and the outer connecting elements 43 is present (see arrows). As a result, the connecting elements 43 move relative to the fastening element and, if there is no play, with the fastening element connected to the lower part 42 of the arrow support. The intermediate bushing 45 that is arranged between the cup springs in this connection is to be considered as part of the fastening element and consequently does not move.

In the area of the four sliding surfaces of this embodiment, friction linings 47 according to the invention are arranged: in each case two between cup spring 44 and connecting element 43 and two between connecting element 43 and lower part 42 of the pendulum support. The friction linings can be clamped between connecting element and cup spring, or between connecting element and lower part of the pendulum support, or, for example, glued or riveted with the lower part of the pendulum support. The friction linings are organically or inorganically-bonded or metal sinter pads.

The friction linings also ensure relatively constant friction values even at high temperatures above 250°, which can be important for the satisfactory functioning of the supports. As an alternative, in this embodiment, a slide plate can also be arranged between the outside sliding lining and the cup spring, so that the sliding lining does not become wedged on the cup spring.

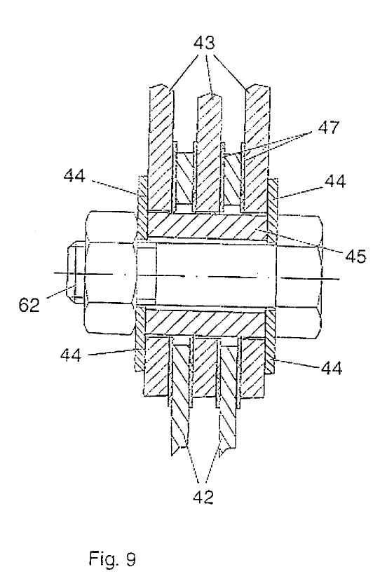

In the exemplary embodiment according to FIG. 7, the play between the shank of the fastening element 62 and the inner part of the pendulum support 42 is present (see arrow). As a result, the outer connecting elements 43 move with the fastening element relative to the lower part 42 of the arrow supports. The intermediate bushing 45 that is arranged between the cup springs is in turn considered to be part of the fastening element and moves accordingly with the fastening element. This embodiment has only two sliding surfaces, between connecting element 43 and lower part 42 of the pendulum support, between which in turn one friction lining 47 each is arranged. Also to obtain four sliding surfaces with the embodiment according to FIG. 7, an additional connecting piece 43 can be provided according to the embodiment of FIG. 9, which then in addition is clamped between the now two-part lower part 42 of the pendulum support.

The exemplary embodiment according to FIG. 8 corresponds as much as possible to the exemplary embodiment according to FIG. 7, but this coupling has only one spring element 44, while on the opposite side, the fastening means is snugly connected directly to the connecting element.

The overall friction force of the pendulum support coupling can be controlled via the number of friction couplings. In contrast, at a specified overall friction force, the spring power or pressing force of the individual couplings can be reduced by increasing the number of friction couplings. This and the additional friction lining in the area of the sliding surfaces reduce the wear or pressing danger of the parts of the pendulum support.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LEGEND

1 Compressor Casing
11 Air Intake Housing
12 Air Outlet
2 Turbine Housing
21 Exhaust-Gas Entry
22 Exhaust-Gas Exit
3 Bearing Housing
31 Bearing Housing Base
4 Pendulum Support
41, 42 Parts of the Pendulum Support That Can be Moved Relative to One Another
43 Connecting Elements
44 Spring Elements, Cup Springs
45 Intermediate Bushing, Clamping Limiter
46 Slide Plate
46 Friction Lining
5 Assembly Base
51 Base Attachment
52, 53 Fastening Means
6, 61, 62 Fastening Means

1. A support for supporting an exhaust-gas turbocharger on a base, the support being made in two or more parts, comprising:
a first part of the support; and
a second part of the support connected in an area of coupling with the first part in such a way that the first part and the second part can be moved relative to one another to change a length of a support in the support direction, wherein the first part of the support and the second part of the support are configured symmetrically in the area of the coupling relative to a plane that runs in the support direction, and wherein the first part of the support and the second part of the support are arranged symmetrically to one another in the area of the coupling relative to the same plane.

2. Support according to claim 1, wherein at least the first part of the support in the connecting area includes several connecting elements and wherein several connecting elements of the first part of the support and the second part of the support are arranged symmetrically to one another.

3. Support according to claim 2, wherein at least one connecting element in each case is arranged on both sides of the second part of the support.

4. Support according to claim 1, wherein in the area of the coupling between the first part of the support and the second part of the support, a friction lining is arranged in each case between surfaces of the parts of the supports.

5. Support according to claim 1, wherein the parts of supports that can be moved relative to one another are connected to one another such that they can be moved only when a force acting on the support in the support direction exceeds a boundary value.

6. Support according to claim 5, wherein the boundary value can be determined by a type and strength of the coupling of the parts of supports that can be moved relative to one another.

7. Support according to claim 6, wherein the second part of the support and the several connecting elements in the connecting area are connected to one another by means of a clamping coupling.

8. Support according to claim 7, wherein the clamping coupling comprises spring elements that clamp together the parts that are connected to one another.

9. Support according to claim 7, wherein the clamping coupling comprises means for limiting the clamping of the clamping coupling in a pressing direction.

10. Exhaust-gas turbocharger with a compressor casing, a turbine housing and a bearing housing, whereby the exhaust-gas turbocharger is supported in an area of the bearing housing by means of a first support and in an area of the turbine housing by means of a second support on a base,
wherein the second support is configured according to claim 1.

11. Support according to claim 2, wherein in the area of the coupling between the first part of the support and the second part of the support, a friction lining is arranged in each case between the surfaces of the parts of the supports.

12. Support according to claim 3, wherein in the area of the coupling between the first part of the support and the second part of the support, a friction lining is arranged in each case between surfaces of the parts of the supports.

13. Support according to claim 2, wherein the parts of supports that can be moved relative to one another are connected to one another such that they can be moved only when a force acting on the support in the support direction exceeds a boundary value.

14. Support according to claim 3, wherein the parts of supports that can be moved relative to one another are connected to one another such that they can be moved only when a force acting on the support in the support direction exceeds a boundary value.

15. Support according to claim 4, wherein the parts of supports that can be moved relative to one another are connected to one another such that they can be moved only when a force acting on the support in the support direction exceeds a boundary value.

16. Exhaust-gas turbocharger with a compressor casing, a turbine housing and a bearing housing, whereby the exhaust-gas turbocharger is supported in an area of the bearing housing by means of a first support and in an area of the turbine housing by means of a second support on a base,
wherein the second support is configured according to claim 2.

17. Exhaust-gas turbocharger with a compressor casing, a turbine housing and a bearing housing, whereby the exhaust-gas turbocharger is supported in an area of the bearing housing by means of a first support and in an area of the turbine housing by means of a second support on a base,
wherein the second support is configured according to claim 3.

18. Exhaust-gas turbocharger with a compressor casing, a turbine housing and a bearing housing, whereby the exhaust-gas turbocharger is supported in an area of the bearing housing by means of a first support and in an area of the turbine housing by means of a second support on a base,
wherein the second support is configured according to claim 4.

19. Exhaust-gas turbocharger with a compressor casing, a turbine housing and a bearing housing, whereby the exhaust-gas turbocharger is supported in an area of the bearing housing by means of a first support and in an area of the turbine housing by means of a second support on a base,
wherein the second support is configured according to claim 5.

20. Exhaust-gas turbocharger with a compressor casing, a turbine housing and a bearing housing, whereby the exhaust-gas turbocharger is supported in an area of the bearing housing by means of a first support and in an area of the turbine housing by means of a second support on a base,
wherein the second support is configured according to claim 6.
